(19) United States
(12) Patent Application Publication
(10) Pub. No.: US 2010/0199668 A1
(43) Pub. Date: Aug. 12, 2010

(54) AIR POWER GENERATOR TOWER

(76) Inventors: Alain Coustou, Talence (FR); Paul Alary, Vaulx-En-Velin (FR)

Correspondence Address: YOUNG & THOMPSON, 209 Madison Street, Suite 500, Alexandria, VA, 22314, US

(21) Appl. No.: 12/063,114

(22) PCT Filed: Aug. 8, 2005
(86) PCT No.: PCT/FR05/50659

§ 371 Date: Apr. 5, 2010

(30) Foreign Application Priority Data
Aug. 11, 2004 (FR) 0408809

(51) Int. Cl. F03G 6/00; H02K 7/18

(52) U.S. Cl. 60/641.8; 290/52

(57) ABSTRACT

The invention relates to continuously mass-producing electric power with a low cost, without pollution, greenhouse gas emission, consumption of limited natural resources, wastes and independently of irregularity of wind conditions. The invention is embodied in the form of a hollow tower-shaped structure flared at the base thereof, surrounded by a greenhouse area and is optimised in order to combine the four following natural forces and effects: a chimney effect, greenhouse effect, Coriolis force and a Venturi effect. The inventive plant comprises, in particular curved structures for activating an artificial and self-sustaining vertex, peripheral flap shutters for involving a wind quantity and pools optimised for storing calories supplied by sun and optionally by effluents of nuclear power plants, different industrial activities or geothermal waters. The production capacity of the inventive power plant is of several hundreds of MW and the production cost of one KW/hour could be substantially low.

This invention relates to a plant for producing energy at low cost.

This invention is intended to propose an alternative to the existing solutions making it possible to continuously produce, on a mass scale, electrical energy at low cost, without pollution, without the emission of greenhouse gas, without the use of scarce natural resources and without waste.

A plant, described in document US 2002/148222, comprising a conduit in which the air made heavier by a water droplet spray at the inlet of the conduit is known for producing electrical energy. At the outlet of the conduit, the plant includes means for converting the energy of the airflow into electrical energy. This technique uses the gravitational force to generate an airflow, with the density of the air being increased beforehand so as to increase the kinetic energy. This solution is not satisfactory because it requires energy to pump the water, move it upward and spray it, which tends to reduce the efficiency of the plant.

Document U.S. Pat. No. 4,497,177 describes a plant comprising a conduit associated with a cliff causing an air downpipe, a water basin covered by a dome promoting the heating of the water by solar energy, and an exchanger provided in the lower portion of the basin. Thus, the solar energy causes the water to evaporate and creates a temperature gradient between the hot water at the surface and the cold water at the bottom of the basin. The inlet of the exchanger opens out above the water level, while the outlet of the exchanger is connected to the air downpipe. The humid air, traversing the exchanger, is cooled, which causes its downward movement in the downpipe. Means are provided inside the conduit for transforming the energy of the airflow into electrical energy. In addition, the basin can be arranged in a circular chamber so as to generate, by the Coriolis force, an airflow rotating above the bath. Wind turbines are then provided to transform the energy of this rotating airflow into electrical energy. As above, this technical solution uses energy to change the water in the basin, which tends to reduce the efficiency of the plant.

Document DE 2755959 describes a plant including a bundle of conduits that is 2000 m high, making it possible to create a rising airflow owing to the differences in pressure between the inlet and the outlet of the conduits. Means for transforming the airflow energy into electrical energy are provided at the inlet of the conduits. According to this technique, the airflow energy is relatively low, unless very high conduits are provided, i.e. for towers higher than 2 km, which cannot be envisaged.

Also, this invention is intended to overcome the disadvantages of the previous plants from which it differs considerably.

To this end, the invention relates to a hollow tower-shaped plant intended to produce electricity by means of a rising airflow, characterised in that the tower includes, in the lower portion, air inlets with baffle walls curved so as to cause the air to rotate and to generate in the tower a whirlwind phenomenon maintained and amplified by the Coriolis force, upstream of the air inlets means for heating the air suctioned into the tower by a chimney effect, means for converting the kinetic energy of the air column into electrical energy, said tower being flared at its base and gradually shrinking so as to accelerate the air by the Venturi effect. Thus, the plant uses four natural forces and effects: the chimney effect, the greenhouse effect, the Coriolis force and the Venturi effect, optionally by making it possible to exploit the wind and the recovery of heat energy.

Other features and advantages will appear from the following description of the invention, given by way of a simple example, in reference to the appended drawings, wherein:

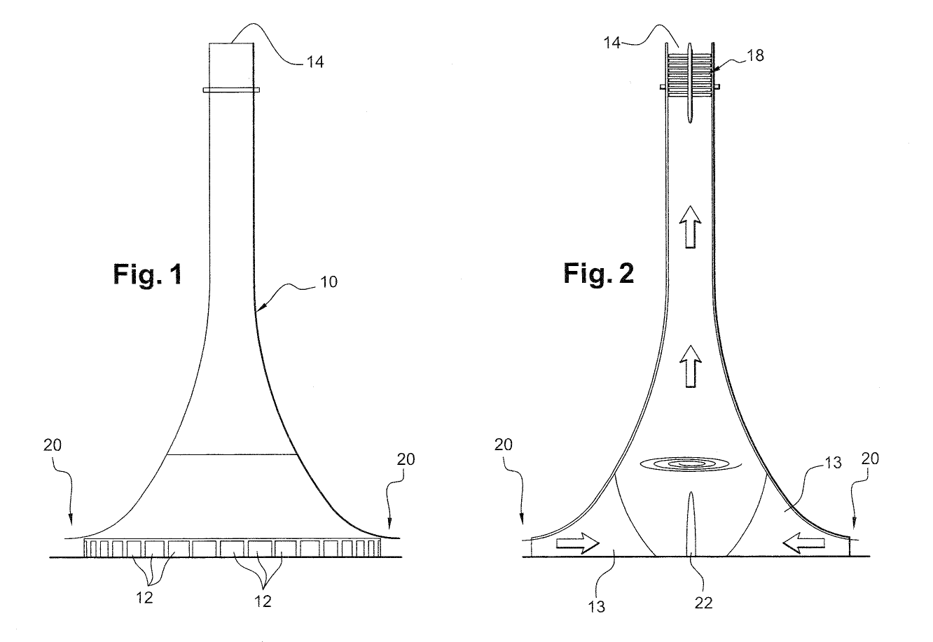

FIG. 1 is an elevation drawing of an air power generator tower according to the invention,

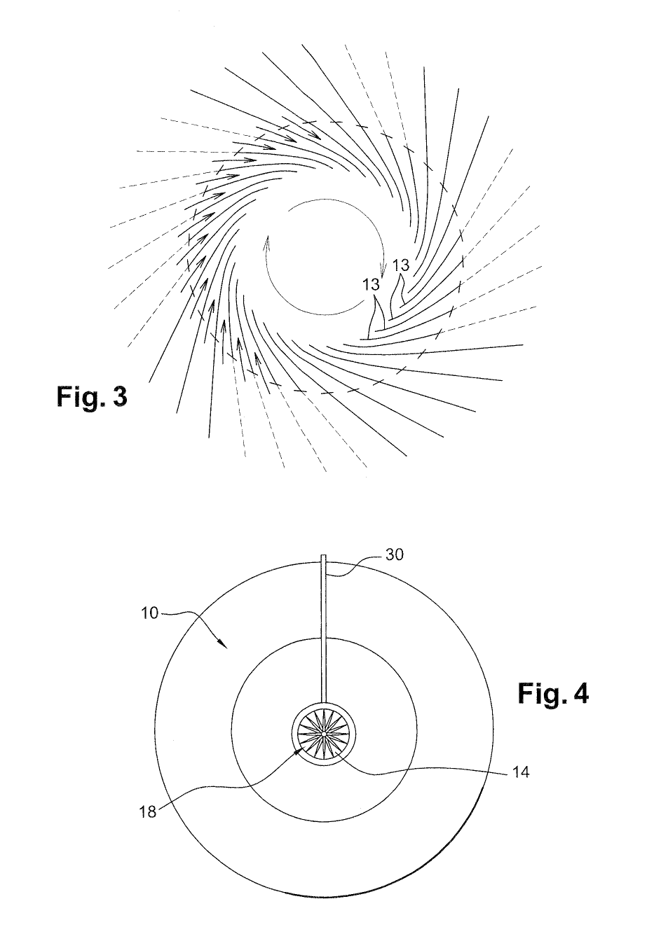

FIG. 2 is a vertical cross-section of the air power generator tower,

FIG. 3 is a diagrammatic drawing showing the inlets at the base of the air power generator tower,

FIG. 4 is a top view,

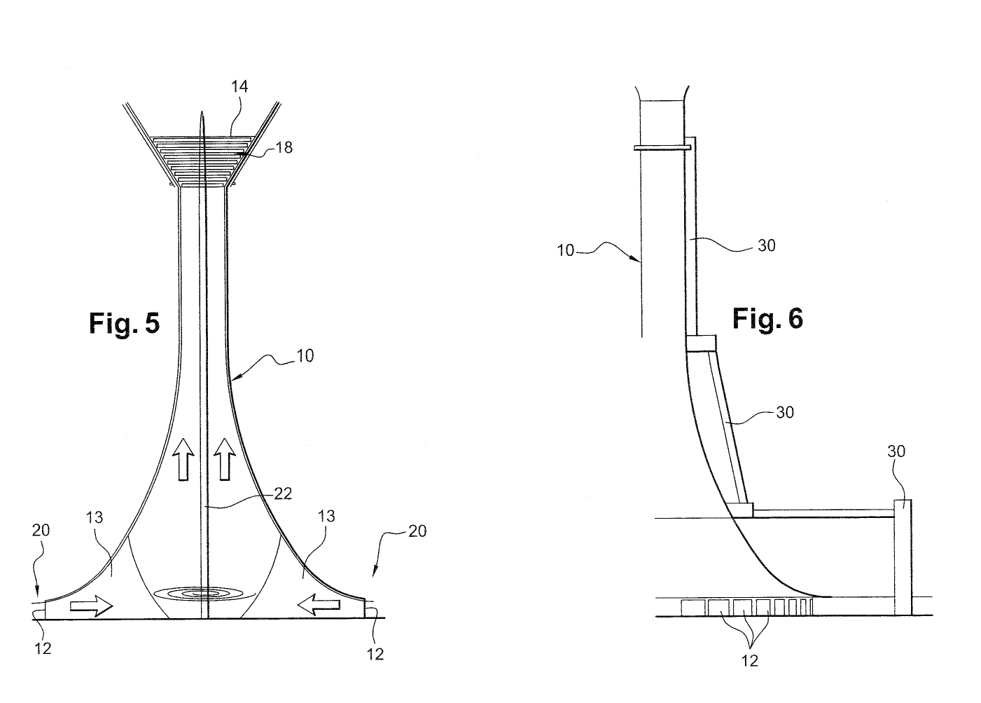

FIG. 5 is a vertical cross-section of an air power generator tower,

FIG. 6 is an elevation drawing of a portion of an air power generator tower showing the possible placement of the external lifts,

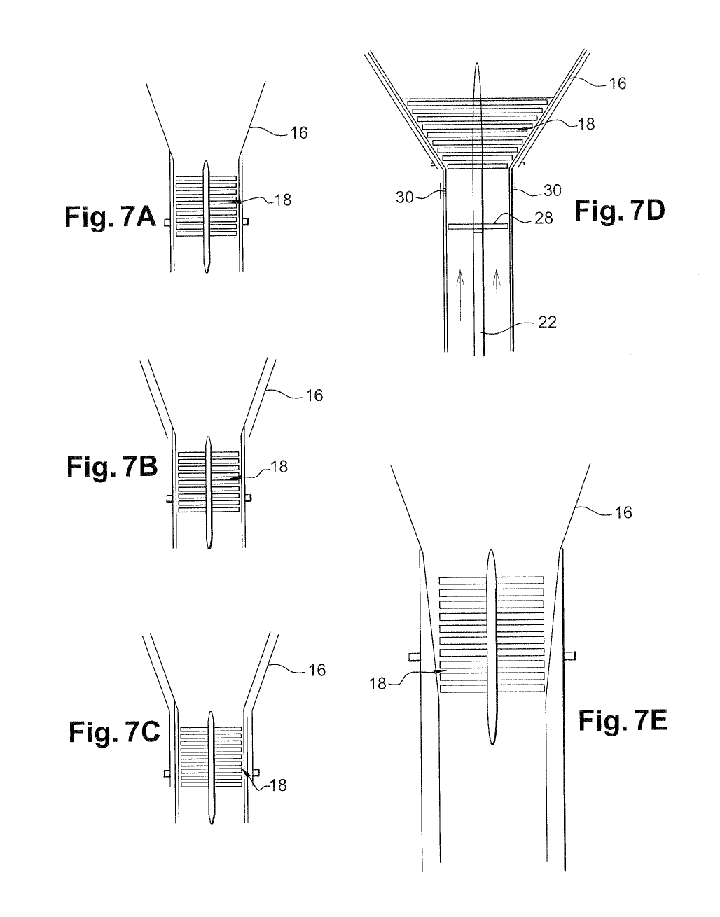

FIGS. 7A to 7E are cross-sections showing alternatives of the upper portion of the air power generator tower,

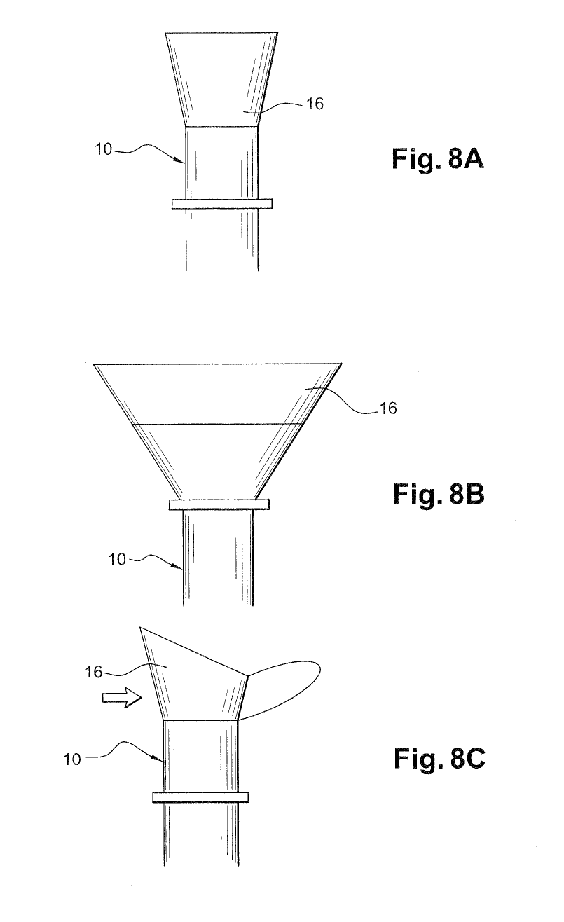

FIGS. 8A to 8C are elevation drawings showing alternatives of the upper portion of the air power generator tower,

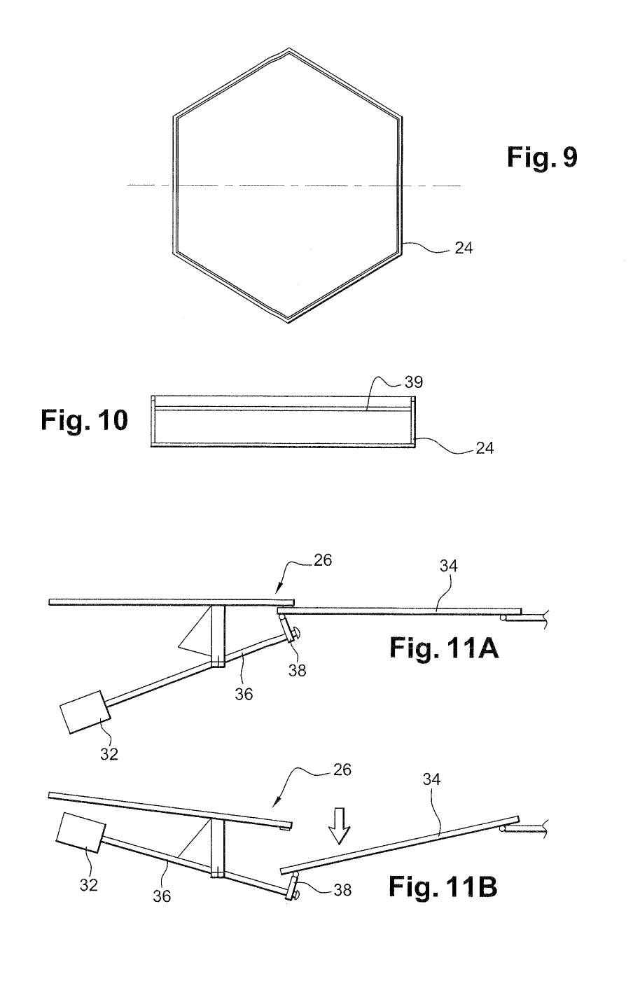

FIG. 9 is a top view of an embodiment of one of the basins capable of being provided around the tower,

FIG. 10 is a cross-section of the basin of FIG. 9,

FIGS. 11A and 11B are diagrams showing an embodiment of the greenhouse cover surrounding the tower, respectively in a first inactive position and in a second position for removal of rainwater.

In the various figures, 10 represents a hollow tower with, in the lower portion, a plurality of inlets defined by baffle plates 13, with, in the upper portion, a through-opening 14 that may or may not be equipped with an outlet shroud 16 (FIGS. 8A to 8C), means 18 for converting the kinetic energy of an airflow into electrical energy, for example at least propellers or turbines. Upstream of the tower inlets, the plant includes means 20 for collecting heat energy, for example in the form of greenhouses.

By way of example, the tower has a minimum height on the order of one hundred metres, and preferably a height on the order of 300 m, not including the outlet shroud. However, it is possible to apply the principle to towers of different sizes. The tower has a base diameter on the order of 150 to 200 metres (for 300-metre tower) and an internal diameter at the base of the conversion means 18 (cylindrical or quasi-cylindrical portion) on the order of 25 to 30 metres (estimation for a 300-m tower).

For example, the area of the heat energy collection means 20 distributed around the base of the structure is on the order of 1 to 5 Km² for a self-contained tower depending on the latitude and the dimensions of the tower. An area on the order of 2 Km² is a reasonable estimation for a 200 to 300 metre tower in an area receiving a large amount of sunlight.

The concept is valid for different dimensions, with heights exceeding one hundred metres and tours over 300 metres being capable of being envisaged.

According to the alternatives, the tour is made of concrete and possibly metal or any other resistant material, suitable for its function. It is suggested to use a reinforced technical concrete for the flared base and the structural frame, the same concrete or steel for the cylindrical or quasi-cylindrical portion and hardened aluminium or a light aeronautical-type alloy for the outlet shroud.

According to an embodiment, the energy collection means 20 comprise greenhouses hanging over the peripheral basins for storing heat energy. These basins are made of concrete or a synthetic material, preferably vat-died black, for example PVC or any other sufficiently resistant plastic, optionally with floating covers made of a UV-resistant vat-died black synthetic material, for example polyethylene, cellular PVC or any other suitable material with a density lower than that of the basin water.

The glazing of the greenhouses must be made of a UV-resistant transparent material, such as glass, PVC, polycarbonate, and so on.

According to an embodiment, the flared base, which provides perfect stability for the assembly, may occupy a bit more than three hectares for a tour 10 that is 300 metres high, and is preferably painted black. The air inlets 12 are arranged around the periphery of this base and can be screened to prevent the accidental ingress of birds or the suctioning of debris brought by the wind.

Between each of the inlets is an inner and/or outer baffle plate 13. The inner plates 13, which may be extended to the outside under the glazing, simultaneously have a structural frame function and are interrupted at the central portion of the structure.

The inner baffle plates 13 have a curved (plan) form as shown in FIG. 3, so as to initiate a rotation movement of the air suctioned in the tower 10, which rotation is amplified in a spiral revolution from the base to the apex and maintains itself by the Coriolis force.

A vertical core 22 is placed in the axis of the tower and ensures the symmetry of the rotation of the air column. As shown in FIG. 5, the core can be raised so as to join the axis of the turbine or propeller system 18. If necessary, it can be held in the axis of the tower by stretched cables. An alternative to this core may consist of a hollow structure with a round cross-section and a variable diameter, in which the use of cables, a lift and/or an emergency escape is possible.

The base of the tower 10 is surrounded by an area of a different type, and the structure may or may not be constructed in a region having water resources.

In a region having hydraulic resources, communicating basins 24 with a hexagon (FIGS. 9 and 10) or quadrangle shape act as relative heat reservoirs for the night. Each basin may be equipped with a black floating cover 39, intended to prevent evaporation.

In dry or desert areas, a ground surface covered with bitumen or concrete painted black provides the same functions.

In both cases, the area considered is on the order of several Km² (2 to 3 Km², for example, in a very sunny area) for a self-contained tower, over which glazing 26 hang, which glazing is very slightly inclined from the centre to the periphery and create a greenhouse effect while guiding the heated air toward the base of the tower. This area can, however, be very substantially reduced when combined with a source of industrial heat energy (nuclear power plants, iron and steel works, etc.). The periphery of the greenhouses can optionally use a lighter and more economical covering material than glass frames, for example a transparent veil made of a synthetic material.

As shown in FIGS. 1 and 2, the diameter of the tower shrinks gradually from the base. This specific feature should cause a considerable acceleration in the rising airflow by a combination with the chimney effect and the Venturi effect.

The upper portion of the tower to the base of the turbines or propellers is cylindrical or has a shape similar to a cylinder, possibly slightly frusto-conical, preferably painted a light colour, such as white.

A device for converting the energy of the air column into electricity, capable of being constituted by a plurality of turbine or propeller stages 18, controlled by sensors and managed by a computer program, is installed just before the apex of the structure. This device may be accompanied by a flare of the tower at its level so as to better evacuate the air column in spite of the conversion of a large portion of its kinetic energy. This device can optionally be preceded by one or more compressor 28 and discharge valve 30 stages in order to remove any excess pressure.

This cylindrical, quasi-cylindrical or flared portion can be covered by a shroud 16 at the turbine outlet so as to optimise their efficiency and reduce any sound disturbances.

Outside, the structure may comprise one or more lifts 30 as shown in FIG. 6, a station for surveillance, maintenance and/or control, places for antennas, transmitters and retransmitters. The access to the base of the lifts and the tower can be provided underground so as to avoid the need to pass through an overheated greenhouse space.

In regular wind areas, annular wind turbines, wind turbines with vertical-axis cups or other wind turbine devices can optionally encircle the cylindrical or quasi-cylindrical portion of the structure, with the tower constituting the axis of rotation of at least one wind turbine device.

In the self-contained operation of the system, the ambient air around the base of the tour, which is generally naturally warmer than that at the apex, is increased in temperature by the greenhouse effect created by the glazed surfaces.

A heat energy reserve is created by the heating of the bitumen ground or black-tinted concrete-covered ground, or, better yet, water basins 24 with a hexagon shape (optimal configuration) or any other shape allowing for regular tessellation of the ground.

When hexagonal basins are used, some may be half-basins in order to provide the spaces necessary for maintenance paths and the placement of the structural frame of the greenhouse effect glazing.

The diameter of the communication ducts between intercommunicating basins is dependent on the maximum desired supply flow. In addition to the ducts provided at the bottom of the walls, a discharge opening from the possible overflow pipe to the neighbouring basins can be provided at the top of each wall. These intercommunicating basins can each be equipped with a floating cover, preferably rigid or semi-rigid, made of a synthetic material (polyethylene or the like) with a density lower than that of the basin water and preferably vat-died.

This cover is black, which enables it to absorb solar heat and prevents the proliferation of algae or moss. A small space is left between the edges of the cover and the walls of the basin to allow the cover to rise or fall with the water level. This cover would be used as needed to prevent evaporation, depending on the availability of water, which is variable according to the site and possibly the period. Its use would also limit the appearance of a vapour plume at the top of the tower. Finally, a system of removable metal bars or cables attached to the apex of the basin walls can be provided in order to secure the floating covers.

The capacity for diurnal storage of heat energy is much higher in the case of basins 26 than in the case of bitumen or concrete.

To complement the solar heating of the air, the flared base of the tower can itself be painted black and insulated with glazing on the portion of which the slope is less than around 60°.

The black absorption and heat energy reserve area surrounding the base of the structure (i.e. an envisaged area on the order of 1 to 4 Km² of basins and/or bitumen or concrete) is normally covered by glazing 26, optionally double glazing, in particular above the warmest portion of the greenhouse, near the base of the tower. A transparent cover made of a lighter and more economical synthetic material can optionally be used at the periphery of the greenhouses. The windows slope slightly from the centre toward the periphery of the greenhouses, and, beneath them, air circulates, which air is thus heated before being suctioned by the base of the tower. The light slope (1 or 2%, for example) promotes the concentration of warm air toward the base of the tower and in particular the removal of rainwater toward the periphery. In addition, devices for partial tilting of some glass frames would facilitate the instantaneous removal of the water toward the basins or the ground, in the case of a particularly large amount of rain, which would otherwise put a dangerous weight on the greenhouse cover. These safety devices provided on the glass frames would be constituted by automatic foolproof balance weight systems 32, as shown in FIGS. 11A and 11B, and would be applicable for any large greenhouse. Thus, some windows 34 are mobile and can pivot slightly so as to allow water to move when they are tilted. To hold them in the inactive position, as shown in FIG. 11A, a lever 36 is provided, one end 38 of which is capable of holding the mobile window in the inactive position by the balance weight 32. When the amount of water exceeds a certain threshold, the weight of the water causes the tilting of the mobile window 34, opposing the balance weight 32, as shown in FIG. 11B. Automatically, when the amount of water is lower than the threshold, the balance weight 32 causes the tilting of the mobile window in the inactive position as shown in FIG. 11A.

According to the alternatives, the glazed area can be encircled at more or less of a distance from the base of the tower by a system of shutters or valves that are automatic or electronically controlled in order to optimise the use of the heated air according to the possible wind. It is thus possible to obtain a slight overpressure capable of reinforcing the chimney effect.

In this case, the shutters or valves are normally open in the portion facing the wind and closed in the opposite portion. The opening of these shutters or these valves can be modulated if there is violent wind in order to prevent an excess overpressure.

If necessary, they can be partially or completely closed so as to slow or interrupt the flow of air suctioned by the tower.

The base of the tower can itself be equipped with shutters of the same type, which would make it possible to stop or restart the plant very quickly. While stopped, the greenhouses would store more energy, which would make the tower a perfect source of electricity for the periods of peak demand, although it is designed to operate continuously.

The placement of the tower on the site of a nuclear power plant, while unnecessary because the towers can operate in a perfectly self-contained manner, should be envisaged when possible. This enables the use of low heat energy of the water of the external circuit for cooling the plant. In winter, this water would be diverted toward the basins relatively close to the tower, from which it would spread closer and closer to the outer basins. In summer, the process would be reversed, with the water coming from the plants supplying the outer-most basins.

A plant could thus provide a surplus of energy to one or more towers, with said surplus varying with the type of plant and the temperature of the effluents recovered.

This solution would have the dual advantage of substantially reducing the area of the greenhouses (therefore reducing the investment cost) and recovering the heat energy unnecessarily discarded into the environment with a hydraulic flow that is often high.

In this case, the covers 39 may not be placed on the basins.

The evaporation would then ensure an evacuation of the heat energy making it possible at least partially to do away with the cooling towers of the plant while increasing the energy of the whirling air, which would increase in humidity. This phenomenon is well known to meteorologists in the case of natural tornadoes, which are often strong above the ocean and weaken or disappear after reaching solid ground.

If the recovered water is hot enough (for example on the order of 40 to 90 degrees), it may be cost-effective to provide a system for transferring the heat energy from the water to the air that is more effective than the simple interface between the surface of the basins and the suctioned air.

Three alternative solutions, among others, may be chosen, optimising the availability of a volume of hot water that is sometimes very large, on the order of some dozens of m3/second with regard to nuclear power plants in which the cooling is not done in a closed circuit, but uses water from a stream or from the sea.

According to a first solution, a network of more or less narrow pipelines, or even actual radiators, is traversed by the air suctioned by the base of the tower and in which the water circulates, providing heat energy, before it is evacuated into the basins or toward the outside.

According to a second solution, there is a system of cascades from the apex of the greenhouses to the basins. These cascades would constitute water curtains coming from the plant and supplied from pipelines placed under the windows of the greenhouses. An alternative of this solution could consist of creating one or more water jets above each basin or the surface for receiving and discharging water.

According to a third solution, in the ideal case in which the water is available under pressure and/or at a high enough temperature, it could be sprayed directly into the air of the greenhouses (fogging), above the basins or the surface for receiving and discharging water.

Solutions 2 and 3 would also have the advantage of more effectively filling the air with humidity, providing greater energy to the captive artificial whirlwind generated in the tower.

In addition, the area of the greenhouses could be further reduced, which would make it possible to envisage the use of double glazing without excessive additional costs. It could even be possible to totally do away with the greenhouse effect if enough hot water is available, and to replace the glazing by any material with good mechanical qualities, in which the covered space would then be intended solely to guide the outside air toward the base of the tower while allowing it to be heated by the heat energy extracted from the water.

Finally, it is possible to envisage reducing the flow of the cooling circuit by pumping less water into the streams, which would be less disruptive for the environment and, by reducing the dilution of the heat energy coming from the plant, would be capable of providing a warmer water flow to the air power generator tower.

In every case, this placement of the towers should allow for a considerable reduction in the cost of the KW/h, which could be established at around 2 cents/KW/h, or even less if water is available at a high enough temperature to apply the above solutions 2 and/or 3.

Other activities, such as iron and steel works, cement works, smelting works, incinerators, and so on, produce a flow of heat energy that is often wasted. This heat energy could also be recovered so as to significantly increase the energy production of the towers. Indeed, even low-calorie liquid or gaseous effluents can increase the energy production of the tower with respect to what is possible in a self-contained operation.

Indeed, this production does depends not on the absolute temperature of the air at the base, but on the difference between said temperature and the temperature of the air outside the apex of the plant, an effective way of circumventing the constraints of Carnot's principle.

Similarly, it is possible to use a thermal spring or geothermics to provide the basins with comparable advantages at the level of the preheating of the basin water. In every case, even a spring with a temperature lower than that desired for the air at the base of the tower can be advantageous, since its temperature is greater than that of the outside air.

According to this hypothesis, the spring can supply the outer basins, with the water spreading closer and closer to the inner basins. The greenhouse then has only to contribute to a complement of the heating, which reduces the number of basins and the windowed area needed.

The warm air trapped under the glazed area and under the flared base of the tower rises in the hollow structure by the chimney effect. It is this effect that causes the warm air to rise in a chimney, rising faster insofar as the chimney is high and the difference between the temperatures of the air at the base and at the apex is high. This phenomenon by itself would not be enough to ensure the efficacy of the device for a tower of which the height is only one to a few hundred metres, with 300 metres appearing to be a good compromise in the search for the optimum yield/cost.

A tower using only the chimney effect and the greenhouse effect should reach a prohibitive height of around 1000 metres in order to be effective, presenting serious problems of placement, construction and cost. This is all the more true insofar as the area of the greenhouses needed is at least double that envisaged for the self-contained use of an air power generator tower.

It is here that the very specific architecture of the device of the invention is involved, making it possible to optimise the energy produced by using two other complementary natural effects, the Coriolis force and the Venturi effect, and possibly to take advantage of an overpressure effect due to the wind.

The air that enters the base of the tower is guided by curved inner and/or outer baffle plates that activate its rotation, this movement being maintained by the Coriolis effect or force.

The internal plates, which are formed between each air inlet recess and can optionally be extended outwardly, can also perform a structural frame function.

This device is complemented by the presence, in the axis of the tower, of a core that is several dozen metres high: on the order of 30 metres, or even more, for a 300 metre tower. Alternatively, the core can rise up to the conversion means 18.

This axial core is intended to ensure satisfactory symmetry of the air rotation in spite of any variations when it is suctioned into the tower.

A whirlwind phenomenon is thus triggered, and is maintained and amplified by the Coriolis effect.

In this way, we obtain a captive and self-maintained tornado. The warm air no longer needs to rise, but is animated by a rapid rotational movement in the same direction as that set for the turbine stages.

The Venturi effect is generated by the specific architecture of the tower, flared at the base, with its internal diameter shrinking as the air rises by the chimney effect. This feature causes a considerable acceleration of the rising and rotating airflow, by the Venturi effect.

With an internal diameter in the upper portion of and a temperature difference of some thirty degrees, the speed of the air column can reach several hundred Km/h. Thus, the energy carried by the air column is considerably focused with respect to what would be obtained by the simple chimney effect in a tubular structure with a constant diameter from the base to the apex. It is only preferable to prevent this speed from exceeding 0.7 times the speed of sound.

The energy of the captive and self-maintained air whirlwind is collected in the upper portion of the tower by conversion means 18 that may consist of a train of multiple turbines or propellers with a variable pitch, with a diameter slightly smaller than the internal diameter of the tower.

The blade-span of these turbines or propellers may be on the order of 25 metres for an internal diameter of 30 metres, or any other recovery device. The space left free between the blades and the internal wall (cylindrical, quasi-cylindrical or slightly frusto-conical) would make it possible to prevent both the smothering of the artificial cyclone and a clogging effect that may be caused by the slowing of the air due to the reduction in energy caused by the turbine train. The peripheral air would be accelerated by the pressure of the rising air and, after having passed the turbine or propeller train, would cause an additional suction effect capable of improving the efficiency of the assembly. Moreover, by slightly reducing the surface of the internal cross-section of the tower at this level, the central core of the turbine or propeller train (in the axis of the “eye” of the artificial cyclone) can reinforce the Venturi effect shortly before the contact between the air column and the turbine or propeller train, without disrupting the rotation of the column.

An alternative shown in FIG. 5 consists flaring the highest portion of the tower in the line of the turbine or propeller train 18, of which the diameter increases from lowest to highest. The increase in the diameter then ensures the evacuation of a constant air volume in spite of the disruption of the air column by the turbines, and increases the efficiency of the assembly.

Another alternative, capable of being combined with one of the previous ones, consists of preceding the turbine or propeller train with one or more compressor stages, driven or supplied with energy by the turbines or propellers, and discharge valves 30. These devices are controlled by sensors (registering speeds of the airflow and the rotation of the turbines or propellers) and with a computer program.

Finally, the upper outlet of the tower can usefully be covered by a shroud 16 intended both to prevent the appearance of turbulence at the outlet of the turbine or propeller train and to minimise any sound disturbances. This shroud can have a frusto-conical or a progressive shape.

According to the alternatives, it is possible to envisage a simple symmetrical shroud, such as the frusto-conical shroud shown in FIGS. 7A, 7E, 8A and 8B, a double shroud, intended to cause a cool air suction phenomenon and cool the periphery of the warm air column after it leaves the turbine or propeller train, this second solution being capable of more effectively reducing the sound disturbances, as shown in FIG. 7B, or a double shroud extended downward to reach the portion of the tower containing the turbines or propellers, as shown in FIGS. 7C and 7D. This enveloping shroud would suction a layer of cool air along this portion, which, optionally combined with external radiators, could help to ensure the cooling of the turbines (or any other system for capturing energy), while satisfying the same functions as the previous solution.

This third formula should therefore be particularly advantageous.

In addition, it is possible to envisage choosing an asymmetrical shroud that is partially or completely mobile. Thus, for example, a wedge-shaped shroud equipped with a wind vane would make it possible to automatically orient the upper portion of the wedge opposite the wind so as to amplify the suction effect of the air column, as shown in FIG. 8C.

It is reasonable for around 50% of the kinetic energy of the air column to be converted into electricity in the version of the tower 10 shown in FIGS. 1 and 2. The other half will then be intended for self-maintenance of the whirlwind phenomenon. The percentage of conversion of the kinetic energy might substantially exceed 75 in the more detailed version of the tower shown in FIG. 5.

The production of electricity thus obtained is actually permanent. In particular, it is practically independent of the wind, unlike in conventional wind turbines. The possible production fluctuations can hardly result from variations in the difference between the temperatures of the air at the base and at the apex of the tower. The wind can nevertheless help to amplify the chimney effect by a double effect of overpressure at the base of the tower and suction at the apex.

The power established can be several hundreds of megawatts for each tower, on the order of 500 MW in optimal activity with some thirty degrees of difference between the air at the base and that at the apex, for a tower 300 metres high.

The power could be even higher in the case of a plant near a nuclear power plant or a major heat-generating industrial activity. The effluents thereof would ensure the supply of the basins with preheated water and therefore a difference in temperature that is both more stable and greater for the same greenhouse area. They could also be placed directly in contact with the air of the greenhouse area by various methods (spray, cascades, water jets, etc.). According to this hypothesis, it is possible to consider reaching and even exceeding a power on the order of 700 MW, or even more in the version of the tower shown in FIG. 5, reaching the order of magnitude of the power of a nuclear reactor for a particularly low cost.

Certain industrial plants sometimes simultaneously have large electrical energy requirements and a need for cooling water. The placement of an air power generator tower can in this case both generate the energy needed for the plant and reduce the thermal waste in the environment.

To conclude, the mass production of electrical energy at a particularly low cost (on the order of 2 cents per KW/h in the first estimation) by present aerothermal power plants, i.e. air power generator towers, would constitute an extremely beneficial economic advantage.

They would also have the advantage of making it possible to recover the heat energy lost both by the power plants and by other industrial plants and to reduce the thermal disturbances of said plants while supplying them with energy.

They can produce electricity with excellent efficiency from low-temperature sources, since a temperature some thirty degrees higher than ambient temperature is already enough to allow them to perform very well.

There are no environmental hazards.

The artificial whirlwind absolutely cannot escape the tower since it is self-maintained by the specific structure of the plant and most of its energy is converted into electricity. In addition, the tower uses the available heat energy, provided by the sun, geothermics or an industrial plant, without producing it itself and without generating waste or greenhouse gases.

The power range is relatively broad between the 100 m tower and the over 300 m tower so as to provide a wide variety of uses, and the power of a 300-m tower with preheating by recovery of heat energy is capable of reaching up to several hundred MW, and even approach the power of a nuclear reactor, while improving its overall efficiency and making it economically and environmentally more beneficial.

1. Hollow tower-shaped plant (10) intended to produce electricity by means of a rising airflow, characterised in that the tower includes, in the lower portion, air inlets (12) with baffle plates (13) curved so as to cause the air to rotate and to generate in the tower a whirlwind phenomenon maintained and amplified by the Coriolis force, upstream of the air inlets (12) means (20) for heating the air suctioned into the tower (10) by a chimney effect, means (18) for converting the kinetic energy of the air column into electrical energy, said tower being flared at its base and gradually shrinking so as to accelerate the air by the Venturi effect.

2. Plant according to claim 1, characterised in that the means (20) for heating the air include water basins (24) covered by greenhouses (16) surrounding the periphery of the tower.

3. Plant according to claim 2, characterised in that some greenhouse portions (34) are mobile so as to tilt when the amount of water on top of said portions exceeds a certain threshold.

4. Plant according to claim 2, characterised in that the basins for storing heat energy are supplied with warm or hot water coming from nuclear power plants or any other industrial plant capable of providing additional heat energy, by the recovery of cooling effluents.

5. Plant according to claim 4, characterised in that it includes devices for transmitting heat energy from the water, coming from a nuclear power plant or any other industrial plant, to the air suctioned by the tower, by using networks of pipelines, radiators, cascades, water jets and/or spraying of hot water.

6. Plant according to claim 1, characterised in that the tower includes, in the upper portion, turbines or propellers with a variable pitch, optionally preceded by one or more compressor stages or any other device capable of recovering the energy of the rising airflow without causing smothering.

7. Plant according to claim 1, characterised in that the baffle plates (13) constitute a structural frame on which the tower is supported.

8. Plant according to claim 1, characterised in that the tower includes a divergent shroud at the upper end of the tower.

9. Plant according to claim 1, characterised in that the upper portion of the tower includes a shroud so as to form an air envelope outside said tower.

10. Plant according to claim 1, characterised in that it includes shutters and/or valves at the periphery of the tower and means (20) for reheating the air so as to control the incoming airflow and to optimise the use of the heated air according to the wind, by obtaining a controlled overpressure.

11. Plant according to claim 1, characterised in that it includes at least one wind turbine device of which the axis of rotation is the upper and cylindrical or quasi-cylindrical portion of the tower.

12. Plant according to claim 3, characterised in that the basins for storing heat energy are supplied with warm or hot water coming from nuclear power plants or any other industrial plant capable of providing additional heat energy, by the recovery of cooling effluents.

13. Plant according to claim 2, characterised in that the tower includes, in the upper portion, turbines or propellers with a variable pitch, optionally preceded by one or more compressor stages or any other device capable of recovering the energy of the rising airflow without causing smothering.

14. Plant according to claim 2, characterised in that the baffle plates (13) constitute a structural frame on which the tower is supported.

15. Plant according to claim 2, characterised in that the tower includes a divergent shroud at the upper end of the tower.

16. Plant according to claim 2, characterised in that the upper portion of the tower includes a shroud so as to form an air envelope outside said tower.

17. Plant according to claim 2, characterised in that it includes shutters and/or valves at the periphery of the tower and means (20) for reheating the air so as to control the incoming airflow and to optimise the use of the heated air according to the wind, by obtaining a controlled overpressure.

18. Plant according to claim 2, characterised in that it includes at least one wind turbine device of which the axis of rotation is the upper and cylindrical or quasi-cylindrical portion of the tower.
